(19) United States
(12) Patent Application Publication
(10) Pub. No.: US 2010/0058418 A1
(43) Pub. Date: Mar. 4, 2010

(54) TELEVISION RECEIVING APPARATUS, INFORMATION PROCESSING APPARATUS, AND DISPLAY METHOD

(76) Inventors: Junichi Yoshizawa, Tokyo (JP); Kentaro Takeda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/478,100

(22) Filed: Jun. 4, 2009

(30) Foreign Application Priority Data
Aug. 29, 2008 (JP) 2008-221783

(51) Int. Cl. H04N 7/173

(52) U.S. Cl. 725/110

(57) ABSTRACT

According to one embodiment, a television receiving apparatus is connected to a server apparatus connected to a plurality of information processing apparatuses, each information processing apparatus includes a first application that is configured to input inputting information to a user who belongs to a group created by the server apparatus and that is configured to output outputting information created by the server apparatus in accordance with the inputting information. The television receiving apparatus includes: a channel transmitting unit configured to transmit channel information that identifies channels to be watched; an output information receiving unit configured to receive the outputting information from the server apparatus for the inputting information inputted by a user of the television receiving apparatus using the first application for transmitting to another user in the group in accordance with the channel information; and a second application configured to display the received outputting information.

### CROSS-REFERENCE TO RELATED APPLICATIONS

This application is based upon and claims the benefit of priority from Japanese Patent Application No. 2008-221783, filed Aug. 29, 2008, the entire contents of which are incorporated herein by reference.

### BACKGROUND

1. Field

One embodiment of the invention relates to a television receiving apparatus, an information processing apparatus, and a display method.

2. Description of the Related Art

In recent years with the progress of digitization of television sets, vigorous discussions have been conducted on television sets accessible to networks, how the services of the networks should be provided through the television platform. Television sets connectable to the networks are being commercialized.

With the development of such a network television sets, Web services, which have traditionally been typically used through Personal Computers (PCs) and cellular phones, are considered as being used through the television sets. In view of the characteristics of the television sets, their nature would be to receive broadcast wave. In view of the nature of the television sets and the usage of the Web services, an aspect of providing services to suit the preference of the users who watch particular television programs, is very important.

Of such services, a communications service (information exchange service) using real time text data, which is so-called messenger or chat, is attractive.

For example, Japanese Patent Application Publication (KOKAI) No. 2001-148841 discloses a technology for forming a television community in which television audience are able to communicate with each other interactively and freely, by forming a community which may be composed of a plurality of terminals of audience synchronized with channel information.

However, inputting information into a television set with a connected keyboard and mouse as in a PC is not all that realistic because it is assumed that the television set is used as a passive device in many cases. Therefore, it is necessary to watch airwaves on the television while conducting an operation for a chat on separate information processing apparatuses such as PCs and cellular phones, which are suitable for inputting information in order to realize, for example, the service of conducting the chat on the community formed by the television audience.

However, under such a system constitution, the users concern tends to be turned on the separate information processing apparatuses rather than on the television. As a result, it is difficult to realize conducting the chat service while watching the television, and therefore the system does not satisfy the needs of all users.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiment of the invention and not to limit the scope of the invention.

FIG. 1 is a block diagram of the communication system according to an embodiment of the present invention;

FIG. 2 is a block diagram illustrating the structure of a television receiving apparatus;

FIG. 3 is a block diagram illustrating the structure of a cellular phone;

FIG. 4 is a block diagram illustrating the structure of a server apparatus;

FIG. 5 is an exemplary view of a created community;

FIG. 6 is a sequence diagram illustrating an overall flow of a service usage process according to the embodiment;

FIG. 7 is an exemplary schematic view of a display screen of the television receiving apparatus;

FIG. 8 is another exemplary schematic view of a display screen of the television receiving apparatus;

FIG. 9 is an exemplary schematic view of a display screen of the cellular phone;

FIG. 10 is another exemplary schematic view of a display screen of the cellular phone;

FIG. 11 is still another exemplary schematic view of a display screen of the cellular phone;

FIG. 12 is still another exemplary schematic view of a display screen of the television receiving apparatus;

FIG. 13 is still another exemplary schematic view of a display screen of the television receiving apparatus;

FIG. 14 is still another exemplary schematic view of a display screen of the television receiving apparatus; and

FIG. 15 is still another exemplary schematic view of a display screen of the cellular phone.

### DETAILED DESCRIPTION

Various embodiments according to the invention will be described hereinafter with reference to the accompanying drawings. In general, according to one embodiment of the invention, a television receiving apparatus is connected to a server apparatus via a network, the server is connected to a plurality of information processing apparatuses, each of the information processing apparatuses includes a first application, and the first application is configured to input inputting information to a user who belongs to a group created by the server apparatus and configured to output outputting information that is created by the server apparatus in accordance with the inputting information. The television receiving apparatus includes: a channel transmitting unit configured to transmit channel information that identifies channels to be watched; an output information receiving unit configured to receive the outputting information from the server apparatus for the inputting information inputted by a user of the television receiving apparatus using the first application for transmitting to another user in the group created by the server apparatus in accordance with the channel information; and a second application configured to display the received outputting information in a display unit.

According to another embodiment of the invention, an information processing apparatus is connected to a server apparatus via a network, and the server apparatus is connected to a plurality of television receiving apparatuses. The information processing apparatus includes: a group receiving unit configured to receive group information that identifies a group created by the server apparatus in accordance with channels watched by a user of the television receiving apparatuses; and an application configured to output outputting information, created by the server apparatus, for inputting information inputted by a user of a designated group, wherein the user of the designated group inputs the inputting information to transmit the inputting information to another user of the designated group that indicates the group of the group information received.

According to another embodiment of the invention, a displaying method is conducted by a television receiving apparatus, the television receiving apparatus is connected to a server apparatus via a network, the server apparatus is connected to a plurality of information processing apparatuses, and the information processing apparatus includes a first application configured to output outputting information created by the server apparatus in accordance with inputting information. The plurality of information processing apparatuses input the inputting information to be transmitted by a user who belongs to a group created by the server apparatus. The displaying method includes transmitting channel information which identifies channels to be watched, from a channel transmitting unit transmits to the server apparatus; receiving, in an output information receiving unit, the output information, created by the server apparatus, from the server apparatus for inputting information inputted by a user of the television receiving apparatus using the first application for transmitting to another user in the group created by the server apparatus in accordance with the channel information; and displaying the received outputting information in a display unit by a second application.

In a communication system according to an embodiment, a television receiving apparatus transmits channel information for identifying a channel being watched by a user, to a server apparatus that provides a chat service, the server apparatus forms a group of users (community) who utilize the service, for each piece of channel-information. The television receiving apparatus and the cellular phone which is another information processing apparatus share the same user ID. The server apparatus transmits output information for the chat to both of the television receiving apparatus and the cellular phone, which share the same user ID.

As a result, the communication system is realized in which the output results are simultaneously displayed on the cellular phone and the television receiving apparatus even if the information is inputted by the PC or cellular phone which are different from the television receiving apparatus. Hereinafter, although the communication system including the server apparatus, which provides the chat service, will be explained as an example, the applicable information exchange service is not limited to the chat service.

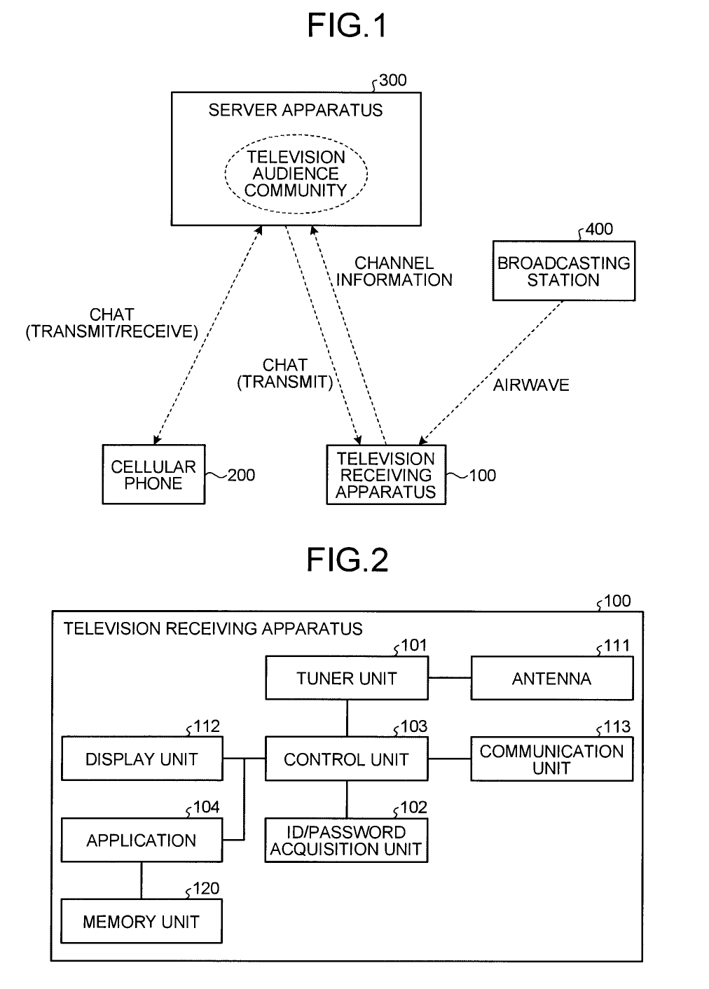

FIG. 1 is a block diagram according to the embodiment of the invention. As illustrated in FIG. 1, the communication system includes a television receiving apparatus 100, a cellular phone 200, a server apparatus 300, and a broadcasting station 400 that transmits the airwaves of the television broadcasting.

The server apparatus 300 dynamically forms the community by the television audience referring to the channel information transmitted from the television receiving apparatus 100 and provides chat services to the users who belong to each community. The services by the server apparatus 300 are provided, for example, by a Web Service Provide (WSP), which provides the chat services on the Internet.

The television receiving apparatus 100 receives the airwaves transmitted from the broadcasting station 400 and displays images of the airwaves of the chosen channel. The television receiving apparatus 100 is provided with the network connecting function and is capable of using services on the network such as the chat service provided by the server apparatus 300. Detailed functions of the television receiving apparatus 100 will be explained later.

The cellular phone 200 includes a UI (User Interface), such as a keyboard and a ten-key which is a special keyboard for inputting numerals exclusively, and is a mobile phone capable of using the chat service by connecting to the server apparatus 300. All information processing apparatuses capable of using the chat service including the PC can substitute for the cellular phone 200. For example, it is possible to constitute the system in such a manner that one user can use the chat service on the cellular phone 200 while the other user can use the chat service on the PC.

Each of the television receiving apparatus 100 and the cellular phone 200 is connected with the server apparatus 300 via a network such as the Internet, but not illustrated in FIG. 1. The network that connects the television receiving apparatus 100 with the server apparatus 300, and the network that connects the cellular phone 200 with the server apparatus 300 may be the same network with each other or different network from each other. Although FIG. 1 illustrates only one television receiving apparatus 100 and only one cellular phone 200, normally a plurality of television receiving apparatuses 100 and cellular phones 200 are connected to the server apparatus 300. The server 300 may include a plurality of physical apparatuses.

The structure of the television receiving apparatus 100 will be explained in detail below. FIG. 2 is a block diagram illustrating the structure of the television receiving apparatus 100. As illustrated in FIG. 2, the television receiving apparatus 100 includes an antenna 111, a display unit 112, a communication unit 113, memory unit 120, a tuner unit 101, an ID/password acquisition unit 102, a control unit 103, and an application 104.

The antenna 111 receives the airwave broadcast transmitted from the broadcasting station 400, and transmits the airwave to the tuner unit 101.

The display unit 112 displays an image that indicates the contents of the channel to be watched, and a screen for the chat that is outputted by an application 104 (will be explained later). The display unit 112 can be formed from display apparatuses such as LCD (Liquid Crystal Display).

The communication unit 113 is connected to external apparatuses such as the server apparatus 300 via the network, and transmits or receives a message (data). The communication unit 113 accesses to the external network such as the Internet via LAN such as the Ethernet (registered trademark) for example. The communication unit 113 includes a protocol stack such as Transmission Control Protocol/Internet Protocol (TCP/IP) and Hypertext Transfer Protocol (HTTP).

The memory unit 120 stores various types of information that are needed for the operation of the television receiving apparatus 100. For example, the memory unit 120 stores a user configuration file that saves the user preference that stipulates the operation of the application 104. The user configuration file, for example, makes the participation and exit of the community follow the change of the channel, or/and stores filtering conditions for participating in the community as the user preference.

The tuner unit 101 selectively receives the airwaves of the preferred channel among the airwaves of the television broadcasting which are supplied from the antenna 111.

The ID/password acquisition unit 102 acquires the user ID and password that identify the user. The user ID and password are transmitted to the server apparatus 300 as authentication information to authenticate the user who uses the chat services. The authentication information is not limited to the user ID and password, but various types of information can be applicable in accordance with the authentication method of the server apparatus 300. For example, the ID/password acquisition unit 102 may be configured to acquire the information that is used in biometrical authentication such as fingerprint authentication.

The ID/password acquisition unit 102 may be structured to acquire the user ID and password, which are inputted by the user, using a virtual keyboard and the like. Alternatively, the ID/password acquisition unit 102 may be configured to acquire the user ID and password by skimming the card in which the user ID and password are embedded.

The control unit 103 controls various processes of the television receiving apparatus 100. For example, the control unit 103 controls television broadcasting receiving process as well as input and output, which are necessary when the users use the chat services. In addition, the control unit 103 implements such processes as AD conversion/DA conversion as needed.

The application 104 is a message switching application for using the chat services provided by the server apparatus 300. The application 104 accomplishes the chat services in cooperation with the control unit 103.

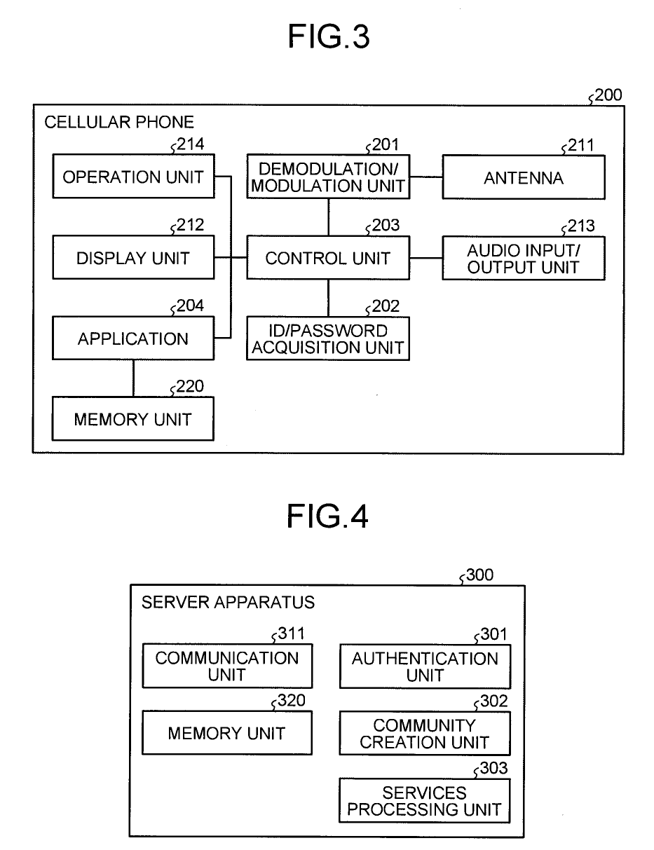

The structure of the cellular phone 200 will be explained in detail below. FIG. 3 is a block diagram illustrating the structure of the cellular phone 200. As illustrated in FIG. 3, the cellular phone 200 includes an antenna 211, a display unit 212, an audio input/output unit 213, an operation unit 214, a memory unit 220, a demodulation/modulation unit 201, an ID/password acquisition unit 202, a control unit 203, and an application 204.

The antenna 211 transmits and receives airwaves of frequency bandwidth of the cellular phone 200 (such as 800 MHz bandwidth and 1.5 GHz bandwidth). The antenna 211 is connected with the demodulation/modulation unit 201.

The display unit 212 displays various pieces of information necessary for telephone functions in accordance with graphics control by the control unit 203. The display unit 212 displays such screens as for the chat, which are outputted by the application 204 (described later).

The audio input/output unit 213 conducts an audio input/output processing that is used in ordinary telephonic functions. The audio input/output unit 213 conducts an audio output process in which the audio input/output unit 213 conducts a D/A conversion for digital audio signals and outputs the D/A converted digital audio signals to a speaker (not illustrated). The audio input/output unit 213 further conducts, for example, an audio input processing in which the audio input/output unit 213 conducts an A/D conversion for the sound inputted from a microphone (not illustrated).

The operation unit 214, for inputting a character string, includes a keyboard, a ten-key that is a special keyboard for inputting numerals exclusively, and buttons.

The memory unit 220 stores various pieces of information necessary for the operation of the cellular phone 200. The memory unit 220 stores, for example, telephone number information and register of received e-mail.

The demodulation/modulation unit 201 demodulates the airwave having a given frequency received via the antenna 211, modulates the information to be sent to the destination into a given frequency and transmits it from the antenna 211.

The ID/password acquisition unit 202 acquires the user ID and password that are sent to the server apparatus 300 for authentication. The ID/password acquisition unit 202 may acquire the user ID and password, which are inputted by the user, using the operation unit 214. Alternatively, the ID/password acquisition unit 202 may be configured to acquire the user ID and password by skimming the card in which the user ID and password are embedded.

The control unit 203 controls various process of the cellular phone 200. The control unit 203 controls, for example, the ordinary telephonic functions and input/output needed in using the chat services.

The application 204 is a message switching application for using the chat services provided by the server apparatus 300. The application 204 accomplishes the chat services in cooperation with the control unit 203.

The structure of the application 204 will be explained in detail below. FIG. 4 is a block diagram illustrating the structure of the server apparatus 300. As illustrated in FIG. 4, the server apparatus 300 includes a memory unit 320, an authentication unit 301, a community creation unit 302, and a services processing unit 303.

The communication unit 311 is connected to external apparatuses such as the television receiving apparatus 100 and the cellular phone 200 via the network, and transmits or receives the message (data). The communication unit 113 includes a protocol stack such as TCP/IP and HTTP.

The memory unit 320 stores various pieces information needed to provide chat services. The memory unit 320 stores, for example, the user ID and password for collation that are necessary in the authentication processing by the authentication unit 301. Furthermore, the memory unit 320 stores the authenticated user ID and information that corresponds to at least one of the television receiving unit 100 and cellular phone 200 which are used by the authenticated user. By referring to this information, for example, when a given user is accessing (login) to both of the television receiving apparatus 100 and cellular phone 200, the server apparatus 300 becomes capable of transmitting the output information corresponding to the character string inputted by the cellular phone 200 not only to the cellular phone 200 but also to the television receiving apparatus 100.

The memory unit 120 of the television receiving apparatus 100, the memory unit 220 of the cellular phone 200, and the memory unit 320 of the server apparatus 300 may be configured by any types of recording media available in our daily life including HDD (Hard Disk Drive), RAM (Random Access Memory), optical disk, and memory card.

The authentication unit 301 authenticates users of each apparatus using the authentication information such as a user ID and password, which have been transmitted from the television receiving apparatus 100 and cellular phone 200. The method of authentication is not limited to the method

The community creation unit 302 creates a community that includes a plurality of users in accordance with predetermined conditions. For example, the community creation unit 302 creates a community for each individual channel. In addition, the community creation unit 302 refers to the channel information transmitted from the television receiving apparatus 100, and adds the user to any one of the created communities. The community may be created at an arbitrary timing, that is, the community may be either pre-created or created upon receiving the channel information.

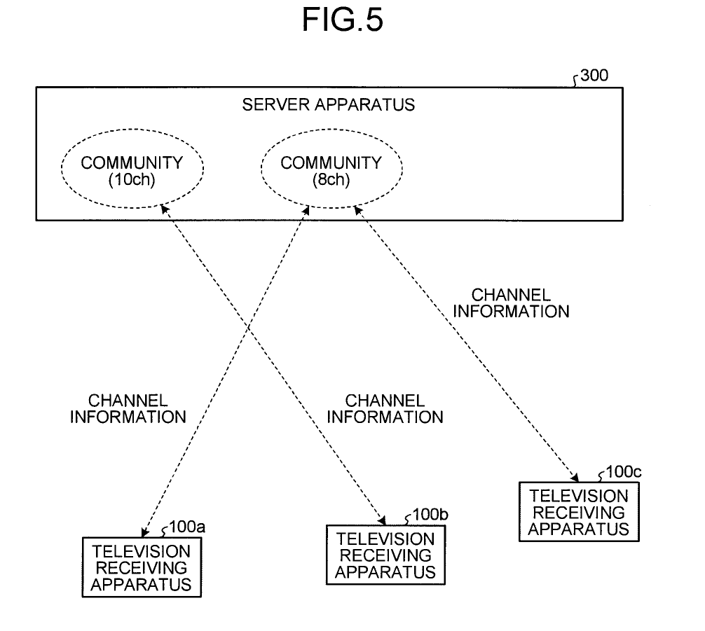

A concrete example of the community created by the community creation unit 302 will be explained below. FIG. 5 is an exemplary view of the created community.

As illustrated in FIG. 5, the server apparatus 300 is connected with a plurality of the television receiving apparatuses 100a to 100c and receives the channel information from each of the television receiving apparatuses 100a to 100c. Each of the television receiving apparatuses 100a to 100c has the same functions as the aforementioned television receiving apparatuses 100 has.

The community creation unit 302 of the server apparatus 300 refers to the channel information received, and adds the user of the television receiving apparatuses 100a and 100c which have transmitted the same channel information to the same community (8ch in FIG. 5). Furthermore, the community creation unit 302 adds the user of the television receiving apparatus 100b to another community (10ch in FIG. 5).

Referring back to FIG. 4, the services processing unit 303 implements processing to materialize the chat service. For example, the services processing unit 303 receives, for each created community, the character string (input information) inputted by the user who belongs to the community using the cellular phone 200 and the like. In accordance with the received character string, the services processing unit 303 creates the output information to output thereof to the application for the chat of each user who belongs to the same community, and transmits the output information to the information processing apparatus each individual user uses. For example, the services processing unit 303 creates the output information by adding the character string, such as the user ID by which the user who has inputted the character string is identifiable, to the character string received, and transmits the created output information to the information processing apparatus each individual user uses.

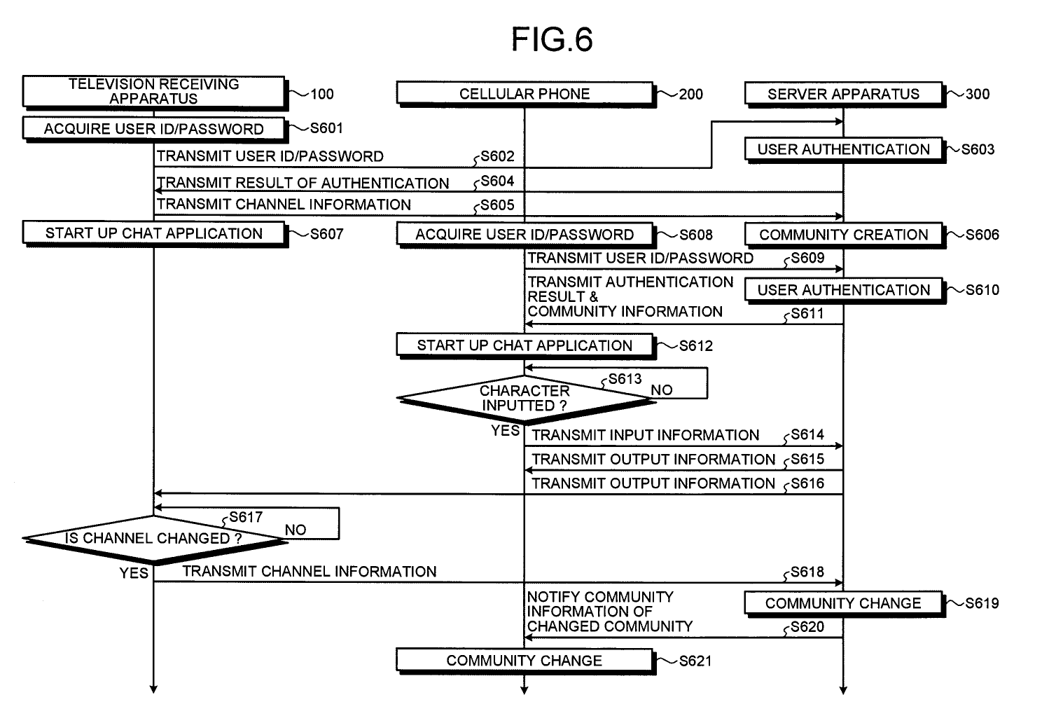

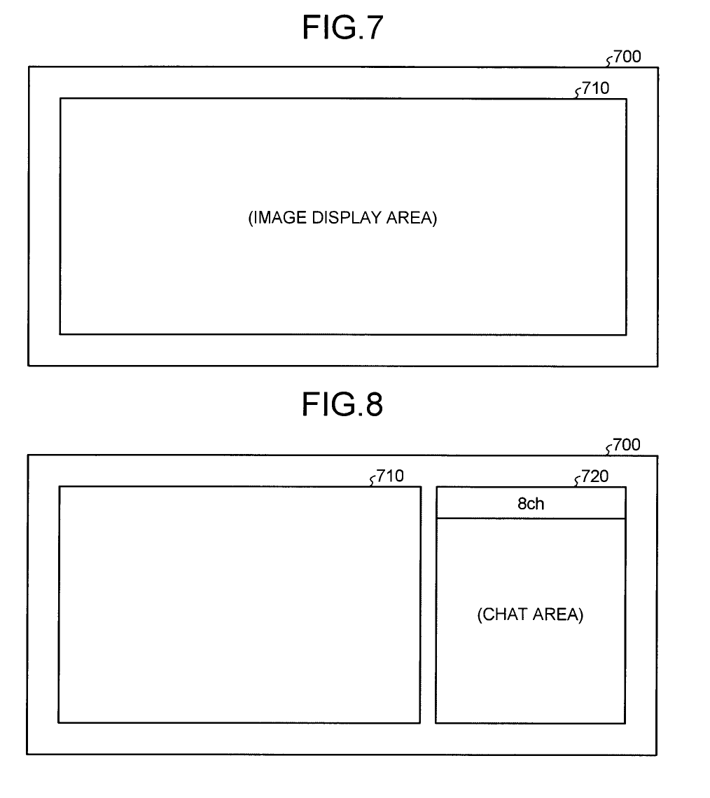

Services usage processing by the television receiving apparatus 100 according to the present embodiment will be explained with reference to FIG. 6 to FIG. 15. FIG. 6 is a sequence diagram illustrating an overall flow of the service usage processing according to the embodiment. FIG. 7 to FIG. 15 are exemplary schematic views of the display screens of the television receiving apparatus or the cellular phone 200.

First, the user turns on the power of the television receiving apparatus 100, inputs the user ID and password which are authentication information to use the chat service using the television receiving apparatus 100. The ID/password acquisition unit 102 of the television receiving apparatus 100 acquires the inputted user ID and password (step S601). The control unit 103 transmits the user ID and password to the server apparatus 300 via the communication unit 113 (step S602).

The authentication unit 301 of the server apparatus 300 authenticates the user of the television receiving apparatus 100 using the received the user ID and password (step S603). The authentication unit 301 of the server apparatus 300 transmits the results of the authentication to the television receiving apparatus 100 via the communication unit 311 (step S604).

When the user is authenticated and watching the television, the control unit 103 of the television receiving apparatus 100 transmits the channel information of the channel the user is watching to the server apparatus 300 via the communication unit 311 (step S605).

The community creation unit 302 of the server apparatus 300 creates a community to provide chat services among the users who are watching the same channel (step S606).

FIG. 7 is an exemplary schematic view of the display screen of the television receiving apparatus 100 before the user uses the chat service. In the state illustrated in FIG. 7, the display screen 700 of the television receiving apparatus 100 exclusively indicates an image display area 710 to display the image of the channel the user is watching.

Referring back to FIG. 6, when two users who are watching the same channel chat, the television receiving apparatus 100 starts up the application 104. More specifically, the television receiving apparatus 100 starts up the application 104 upon detecting that the user has pressed a predetermined remote control button of the television receiving apparatus 100 (step 607).

FIG. 8 is an exemplary schematic view of the display screen of the television receiving apparatus 100 after the application 104 is started up. As illustrated in FIG. 8, after the application 104 is started up, a chat area 720 for indicating the output of the application 104 is further displayed in the display screen 700.

The method of starting up the application 104 is not limited to the aforementioned method. For example, the application 104 may be started up by the television receiving apparatus 100 when the user starts up the application 204 by the cellular phone 200. In this case, the cellular phone 200 transmits start-up information, which indicates the application 204 is started up, to the server apparatus 300. The server apparatus 300 transmits the start-up information to the television receiving apparatus 100 corresponding to the cellular phone 200 that has transmitted the start-up information to the server apparatus 300. Then the control unit 103 starts up the application 104 in accordance with the start-up information.

Referring back to FIG. 6, when the user conducts the input for the chat, the application 204 is started up by the cellular phone 200. More specifically, the ID/password acquisition unit 202 acquires the user ID and password inputted by the user with the cellular phone 200 (step S608). The control unit 203 transmits the user ID and password to the server apparatus 300, via the demodulation/modulation unit 201 and antenna 211, to log in to the server apparatus 300 (step S609).

The authentication unit 301 of the server apparatus 300 authenticates the user of the cellular phone 200 using the received user ID and password (step S610). The authentication unit 301 transmits the results of the authentication and community information to the cellular phone 200 via the communication unit 311 (step S611). The community information indicates the information that can identify the community. At this step the server apparatus 300 can determine which community the authenticated user belongs to. For this reason, when the user is authenticated, the authentication unit 301 transmits the community information to the cellular phone 200; the community information is the information about the community the user belongs to.

When the user is authenticated, the control unit 203 of the cellular phone 200 starts up the application 204 (step S612). The application 204 displays the screen on the display 212 unit for chatting in a designated community which represents the community of the transmitted community information.

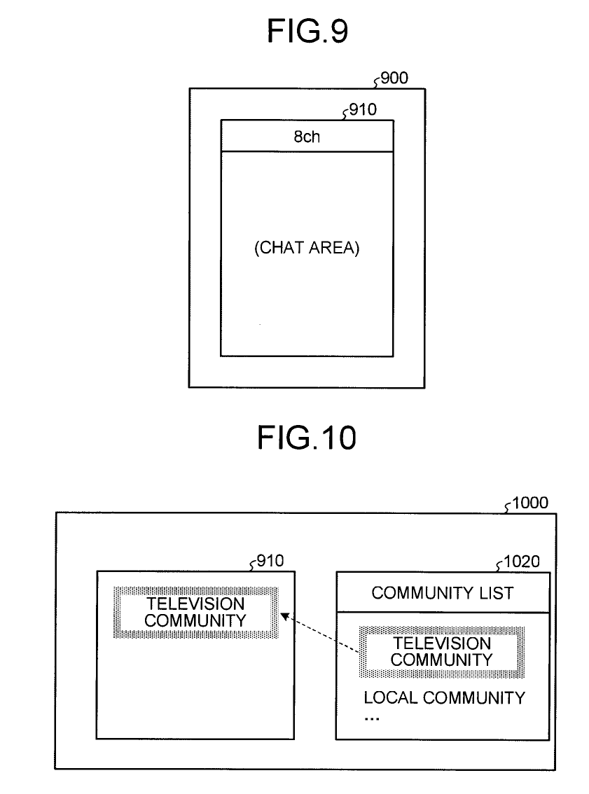

FIG. 9 is an exemplary schematic view of the display screen of the cellular phone 200 after the application 204. As illustrated in FIG. 9, a chat area 910 for indicating the output of the application 204 is displayed in the display screen 900 of the cellular phone 200. As the community information of the community of the user who watches 8ch is received, FIG. 9 illustrates the chat area 910 for conducting the chatting in the community.

The display screen 900 in FIG. 9 is an example, therefore the display screen 900 may be structured to display in such a manner that the user can choose a desired community. FIG. 10 illustrates an example in which the user can choose a desired community.

According to the example illustrated in FIG. 10, the display screen 1000 includes a list display area 1020 for indicating a list of the community from which the user can choose the desired community. In the list display area 1020, for example, the community that can be identified by the community information received from the server apparatus 300 is selectively indicated. The user selects the desired community from the list of the community as the designated community.

Referring back to FIG. 6, the user inputs the character string in the application 104 which is started up in the aforementioned manner. The control unit 203 determines whether or not the character string is inputted from the operation unit 214 (step S613). If the character string is not inputted (step S613: NO), the control unit 203 waits for the character string to be inputted.

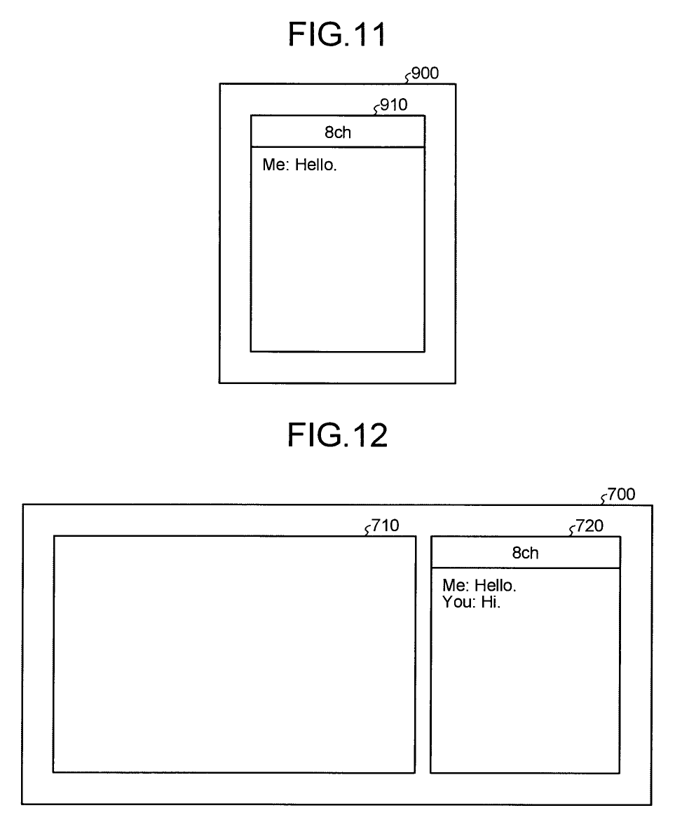

FIG. 11 illustrates an example of the display screen where the character string is inputted. FIG. 11 illustrates an example of the display screen 900 where “Hello” is inputted as the character string.

Referring back to FIG. 6, when the character string is inputted (step S613: YES), the control unit 203 transmits the inputted character string to the server apparatus 300 as the input information via the demodulation/modulation unit 201 and the antenna 211 (step S614).

The services processing unit 303 of the server apparatus 300 creates the output information which corresponds to the received input information, and transmits the output information to the cellular phone or PC of the user who belongs to the same community with the person who inputted the input information (step S615). Furthermore, the services processing unit 303 transmits the output information to the television receiving apparatus 100 when the user who belongs to the community is logging in from the television receiving apparatus 100 too (step S616).

The control unit 103 of the television receiving apparatus 100 receives the output information via the communication unit 113 and transmits the output information to application 104. The application 104 displays the output information on the chat area 720 of the display screen.

FIG. 12 is an exemplary schematic view of the display screen displaying the output information transmitted from the server apparatus 300. FIG. 12 illustrates an example of display screen 700 of the television receiving apparatus 100 where another user inputted “Hi” after the user of the cellular phone 200 has inputted the character string “Hello” as illustrated in FIG. 11.

According to the present embodiment, when the user inputted the character string of chat from the cellular phone 200, it is possible to display the output information, which corresponds to the inputted character string, not only on the display screen of the cellular phone 200 but also on the display screen of the television receiving apparatus 100.

Referring back to FIG. 6, when the user changes the channel the control unit 103 determines whether the channel has been changed (step S617), if the channel has not been changed (step S617: NO) the control unit 103 waits the channel to be changed.

If the channel has been changed (step S617: YES) the control unit 103 transmits the channel information of the changed channel to the server apparatus 300 (step S618).

The community creation unit 302 of the server apparatus 300 changes the community, in which the user of the television receiving apparatus 100 participates, to the community of the changed channel (step S618).

Actions during the change of the channel are not limited to aforementioned actions. The communication system may be structured in such manner, for example, during the change of the channel, a message asking whether or not change the community may be displayed on the display screen, and the community may be changed only when to change the community is designated by the user.

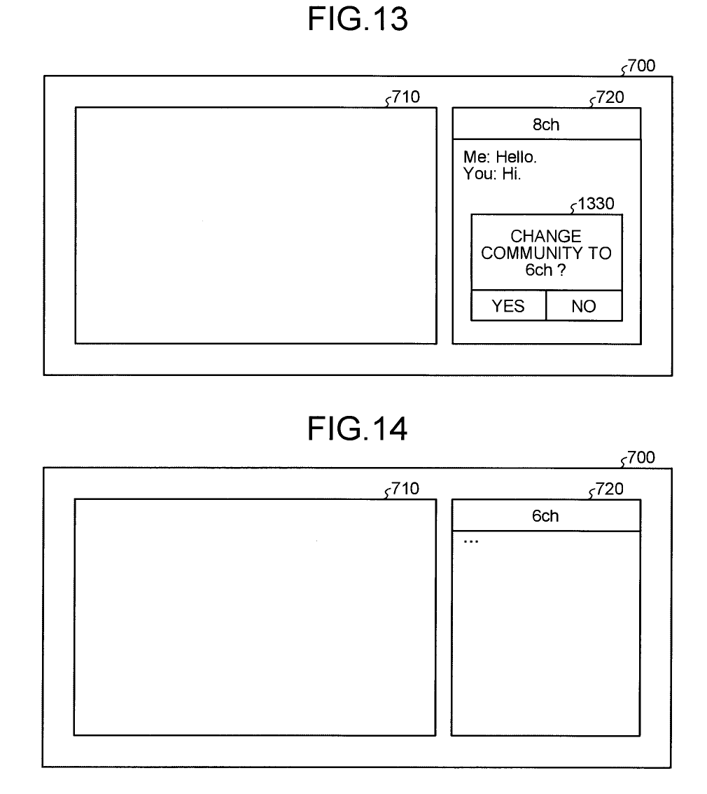

FIG. 13 is an exemplary schematic view of the display screen when the communication system is structured in the aforementioned manner. FIG. 13 illustrates an example when the message 1330, confirming whether or not change to the community that corresponds to 6ch when the channel the user watch is changed from 8ch to 6ch, is displayed.

FIG. 14 illustrates an exemplary schematic view of the display screen when changing of the community is designated in FIG. 13. As illustrated in FIG. 14, the screen of the application 104 is displayed on the chat area 720; the application 104 is changed to chat in the community of the new channel (6ch) in accordance with the change of the channel.

Referring back to FIG. 6, the services processing unit 303 of the server apparatus 300 informs the cellular phone 200, which is used by the user of the television receiving apparatus 100, of the community information of the changed community (step S620).

The application 204 of the cellular phone 200 changes the action in such a way that the community of the received community information to chat as the designated community, and renew the display screen (step S621).

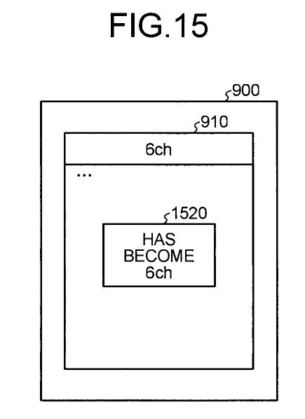

FIG. 15 illustrates an exemplary schematic view of the display screen of the cellular phone 200 when the community has been changed. FIG. 15 illustrates an example of the display screen 900 when the community that corresponds to 8ch has been changed to the community that corresponds to 6ch as illustrated in FIG. 11, for example. As illustrated in FIG. 15, the communication system may be structured in such a manner that the message 1520 that indicates the community has been changed is displayed.

The communication system may be configured in such a manner to act as described bellow during the change of the channel. For example, the communication system may be configured so as to continue using the community that corresponds to the channel before the change even after the channel has been changed. Furthermore, it is possible to store setting information that indicates whether or not change the community dynamically following the change of the channel, and to determine the action during the change of the channel based on the setting information. In this case, for example, during the logging-in the television receiving apparatus 100 transmits the setting information to the server apparatus 300, the server apparatus 300 controls the change of the community referring to the setting information when the channel is changed.

Furthermore, in the community structure, it is possible to conduct filtering in accordance with the information of that other than the audience. For example, the communication system may be structured to form the community for each area the users reside. The communication system may be structured to form the community to which other users designated by the user belong. As a result, it is possible to form a community preferable to the users.

The communication system according to the present embodiment, the channel information of the channel being watched is transmitted to the server apparatus that provides the chat service, then the server apparatus forms community for the user who uses the service for each individual channel information. The server is capable of transmitting the output information for the chat to both the television receiving apparatus and cellular phone, which are used by the same user.

When both the television receiving apparatus and the cellular phone are being used by the same user, if the channel is changed by the television receiving apparatus, and the community to participate in is changed, the community of the application for the chat that is operable on the cellular phone can also be changed at the same time. According to the aforementioned structure, it is possible to improve the operability of the information exchange service such as the chat service that uses the television.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A television receiving apparatus connected to a server apparatus via a network, the server being connected to a plurality of information processing apparatuses, each of the information processing apparatuses including a first application, the first application being configured to input inputting information to a user who belongs to a group created by the server apparatus and configured to output outputting information that is created by the server apparatus in accordance with the inputting information, the television receiving apparatus comprising:
a channel transmitting unit configured to transmit channel information that identifies channels to be watched;
an output information receiving unit configured to receive the outputting information from the server apparatus for the inputting information inputted by a user of the television receiving apparatus using the first application for transmitting to another user in the group created by the server apparatus in accordance with the channel information; and
a second application configured to display the received outputting information in a display unit.

2. The television receiving apparatus according to claim 1, wherein
the second application displays the outputting information in an outputting area of the display unit, wherein the outputting area is different from a display area of the display unit that displays images of the channel being watched by the user.

3. The television receiving apparatus according to claim 1, further comprising:
a start-up information receiving unit configured to receive start-up information that indicates the user of the television receiving apparatus has started up the first application; and
a start-up unit configured to start up the second application upon receiving the start-up information.

4. An information processing apparatus connected to a server apparatus via a network, the server apparatus being connected to a plurality of television receiving apparatuses, the information processing apparatus comprising:
a group receiving unit configured to receive group information that identifies a group created by the server apparatus in accordance with channels watched by a user of the television receiving apparatuses; and
an application configured to output outputting information, created by the server apparatus, for inputting information inputted by a user of a designated group, wherein the user of the designated group inputs the inputting information to transmit the inputting information to another user of the designated group that indicates the group of the group information received.

5. The information processing apparatus according to claim 4, wherein
the group receiving unit is further configured to receive changed group information that is created by the server apparatus in accordance with channel changed by the user with the television receiving apparatuses; and
the application is configured to output the outputting information, created by the server apparatus, for the inputting information inputted by the user of the designated group, wherein the application inputs the inputting information to be transmitted to another user of a new designated group, and the new designated group is the group of the changed group information.

6. A displaying method conducted by a television receiving apparatus, the television receiving apparatus being connected to a server apparatus via a network, the server apparatus being connected to a plurality of information processing apparatuses, the information processing apparatus including a first application configured to output outputting information created by the server apparatus in accordance with inputting information, wherein the plurality of information processing apparatuses input the inputting information to be transmitted by a user who belongs to a group created by the server apparatus, the displaying method comprising:
transmitting channel information which identifies channels to be watched, from a channel transmitting unit transmits to the server apparatus;
receiving, in an output information receiving unit, the output information, created by the server apparatus, from the server apparatus for inputting information inputted by a user of the television receiving apparatus using the first application for transmitting to another user in the group created by the server apparatus in accordance with the channel information; and
displaying the received outputting information in a display unit by a second application.
